(19) United States
(12) Patent Application Publication
(10) Pub. No.: US 2009/0015413 A1
(43) Pub. Date: Jan. 15, 2009

(54) WIRELESSLY TRANSMITTING BIOLOGICAL PARAMETERS

(75) Inventors: Pedro R. GELABERT, Allen, TX (US); Steven C. BARTLING, Plano, TX (US); Steven C. LAZAR, McKinney, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/236,299

(22) Filed: Sep. 23, 2008

Related U.S. Application Data
(63) Continuation-in-part of application No. 11/459,085, filed on Jul. 21, 2006.

(51) Int. Cl. G08B 13/14; H04Q 5/22

(52) U.S. Cl. 340/572.1; 340/10.4

(57) ABSTRACT

A radio frequency identification (RFID) tag is disclosed that comprises a transceiver and a component coupled to the transceiver. The component is adapted to collect at least one biological parameter. The transceiver is adapted to wirelessly receive power from a base device, where the power received from the base device is used to power the component.

### CROSS-REFERENCE TO RELATED APPLICATION

This application claims priority as a Continuation-in-Part (CIP) to the U.S. patent application having Ser. No. 11/459,085, filed on Jul. 21, 2006 and entitled “RFID Power From Handset Transmissions,” incorporated herein by reference.

### BACKGROUND

Medical patients often require monitoring of various biological parameters (e.g., heart rate, blood pressure, lung sounds, etc.) to ensure that they receive proper care. Various types of sensors are used to accomplish such monitoring. The sensors generally detect a biological parameter, convert that parameter to one or more digital signals, and transfer the digital signals to a separate processing system via one or more wires. For example, a pulse sensor attached to a patient's chest may transfer a signal to a pulse monitoring device in the patient's hospital room with each heartbeat.

These wires are cumbersome and are prone to tangling and unplugging due to patient movement. General wireless systems remedy this problem but require significant amounts of power to transmit sensed data, leading to the use of bulky and heavy batteries attached to the sensors. The average size of the batteries imposes a restriction on the amount of time these sensors can be utilized. Furthermore, the self-discharge nature of the batteries imposes a limited shelf-life. Rechargeable batteries have been proposed to overcome these issues, but they must be recharged and thus unused for periods of time, thereby restricting the use of the sensors.

### BRIEF SUMMARY

In accordance with at least some embodiments of the invention, a radio frequency identification (RFID) tag comprises a transceiver and a component coupled to the transceiver. The component is adapted to collect at least one biological parameter. The transceiver is adapted to wirelessly receive power from a base device, where the power received from the base device is used to power the component.

In at least some embodiments, a method comprises a wireless device receiving power from at least one of an RFID reader and a non-RFID mobile communication device. The method also comprises the wireless device obtaining biological information from a biological specimen, where the obtainment of the biological information is powered by the received power. The method further comprises transmitting the biological information to the RFID reader or to the non-RFID mobile communication device.

In at least some embodiments, a system comprises means for receiving power from at least one of an RFID reader and a non-RFID means for communication. The means for receiving is also for obtaining biological information from a biological specimen. The obtainment of the biological information is powered by the received power. The means for receiving is also for transmitting the biological information to the RFID reader or to the non-RFID means for communication.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .”. Also, the term “couple” or “couples” is intended to mean either an indirect or direct connection. Thus, if a first device couples to a second device, that connection may be through a direct electrical or wireless connection, or through an indirect electrical or wireless connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a system in accordance with embodiments of the invention;

FIG. 2 shows an illustrative implementation of the system disclosed herein, in accordance with embodiments;

FIG. 3 shows an illustrative block diagram of the system disclosed herein, in accordance with embodiments; and

FIG. 4 shows a flow diagram of an illustrative method in accordance with various embodiments.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

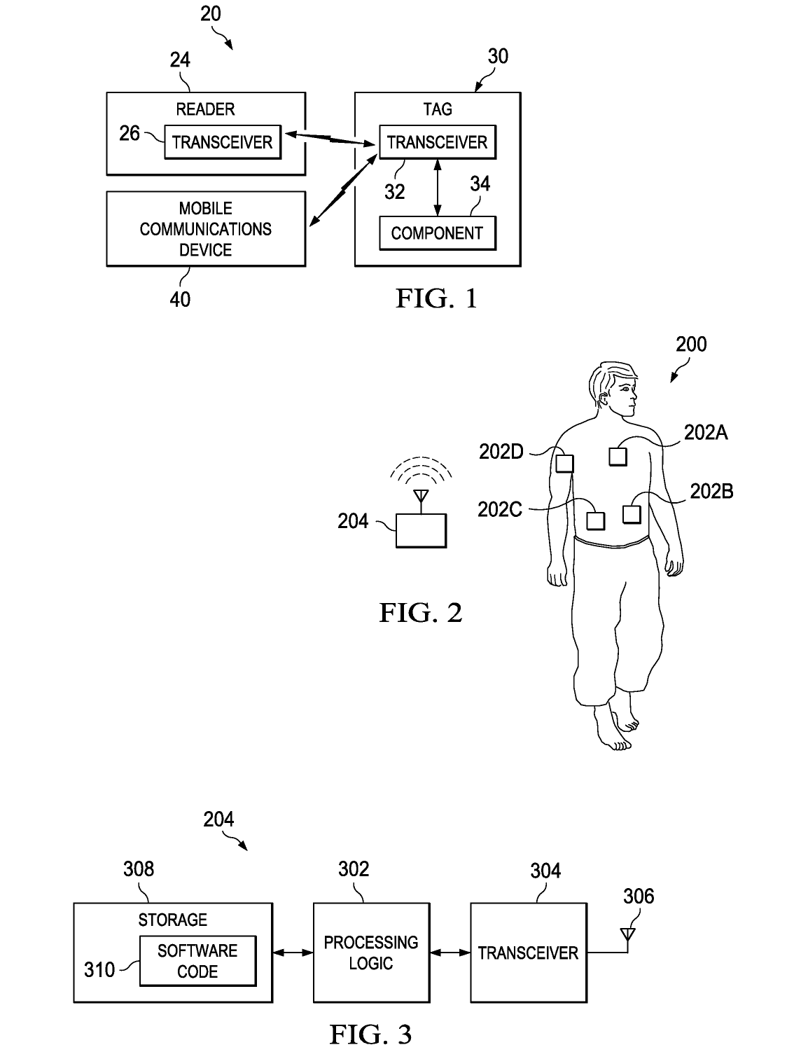

FIG. 1 shows a preferred embodiment of the invention in which a reader 24 is able to wirelessly communicate with a tag 30. A mobile communication device 40 (e.g., a cellular telephone, wireless PDA, etc.) is also shown. The reader 24 comprises a transceiver 26. The tag 30 comprises a transceiver 32 and a component 34. If desired, other components may be included within the reader 24 and/or tag 30. The reader 24 and/or tag 30 may be RFID-compliant in accordance with some embodiments, and comply with other communication protocols in accordance with other embodiments.

Via the transceivers 26 and 32, the mobile device 40 and tag 30 wirelessly communicate with each other. In accordance with one embodiment of the invention, the reader 24 and the tag 30 are provided in accordance with the radio frequency identification (RFID) protocol. As such, the reader 24 comprises an RFID reader and the tag 30 comprises an RFID tag. Unless otherwise specified, as used herein, the term “tag” is not limited to the RFID context. The tag 30 may be positioned at a relatively fixed location such as on a wall, furniture, or piece of equipment. Other embodiments comprise wireless devices other than RFID-based devices. For example, devices 24 and 30 may comprise ultra wide band (UWB) transceivers. The mobile communication device 40 preferably is not an RFID reader or RFID-compliant at all.

The reader 24 emits a periodic wireless beacon signal that, when in range of the tag's transceiver 32, causes the tag 30 to automatically echo back a wireless response signal along with an identifier associated with the tag. In general, the transceiver 32 reflects RF power (received from the reader) in a coded manner back to the reader 24. In at least some embodiments, the identifier differentiates the tag 30 from other tags. Upon receipt of the response signal, the reader 24 is able to determine that the reader is within range of the tag 30. The reader's 24 beacon signal may be automatically emitted at predetermined fixed or programmable periodic intervals. Additionally or alternatively, the reader 24 can be manually activated by its user to emit a beacon.

The tag 30 preferably is “passive” meaning that the tag does not have its own source of power. Instead, the tag's transceiver 32 derives power for the tag to operate from the wireless signal received from the reader 24. In accordance with embodiments of the invention, the tag's transceiver is also capable of deriving power from wireless signals transmitted by the mobile communication device 40. In embodiments in which the mobile communication device 40 comprises a cellular telephone, the communication device emits periodic wireless signals (“beacons”) to associate with, or maintain association with, a base station. When the tag 30 is within range of the mobile communication device 40 and is not in operative communication with reader 24, such periodic cellular signals transmitted from the mobile communication device are detected by the transceiver 32 in the tag 30 even though such wireless signals were intended for a base station for association purposes. In effect, tag 30 extracts operational power from cellular signals transmitted by the mobile communication device 40 intended for a base station.

The tag's receiver may be designed to operate in several modes. (1) Operation as a standard RFID receiver in which the tag gathers energy via RF interrogation at the standard RFID frequencies. (2) Operation as a cellular-mode receiver, in which energy is gathered from one or more of the standard cellular uplink frequencies. Beacons from the cellular handset may be used to prompt the RFID device to transmit its information or to perform other information gathering tasks as outlined below. Transmission (reflection/translation) of the RFID signal is in the RFID band. In this mode, energy harvesting of a nearly continuous RF signal source occur. (3) Operation as a dual-mode receiver, gathering energy from either standard RFID or cellular frequencies. In this mode, prompting of the RFID device may be either through the RFID or cellular frequency signals. As before, the reflection/translation of the RFID interrogation signal is in the RFID band. (4) Operation in which the Radio frequency source is not restricted to a standard RFID reader or cellular frequency signals.

The electrical power derived by the tag's transceiver 32 from the mobile communication device 40 and/or from the reader 24 preferably is used to power the component 34. The component 34 can be any type of, or part of, a peripheral device. Examples of such a peripheral device include a keyboard and a sensor. As a sensor, the component 34 may comprise a temperature sensor, a pressure sensor, or a physiological sensor (i.e., a sensor implanted in the human body). With power derived from the mobile communication device's wireless signal, the tag 30 could power up the component 34 to, for example, take a reading such as temperature, pressure, blood oxygen level, etc. The reading could then be stored in non-volatile memory in the component 34 or transceiver 32 for transmission to the mobile communication device 40 or reader 24.

In accordance with at least some embodiments of the invention, the component 34, and tag 30 in general, preferably can be effectively operated with brief spurts of operational power provided by the received RF power, rectified and stored in a capacitor or equivalent component. That is, the tag 30 should be able to perform a task, or at least part of task, with power provided to it at discrete times. For example, the mobile communication device 40 may emit beacons at a rate of 5 beacons per second. The tag 30, and component 34 specifically, preferably operate to perform the function associated with the component 34 (e.g., sensor) with power arriving briefly 5 times per second.

The ability of the tag 30 to harvest energy from mobile devices such as cell phones and WIFI devices enables the passive tag to perform other operations without an RFID reader such as capturing and recording environmental information via, for example, integrated temperature, light, pressure, RF, or audio sensors. In the case of RF sensing, the tag may be capable of receiving energy over a broad spectrum of frequencies. It may be able to capture and record the ID of a beaconing GSM cell phone or a mobile WIFI, BT, or WIMAX device. In the case of RF sensing, the RFID device 30 behaves in one mode as a normal RFID device when it is communicated with using specified standard protocols. Device 30 may behave as a mobile device powered sensor/recorder whenever a nearby mobile device provides signal strength strong enough for it to do so and the device 30 is not in operative communication with RFID reader 24. In this latter mode of operation, the device may simply write to an internal circular buffer (e.g., in the component 34) the data that it has sensed. If there is some means of extracting relative state or time between sensed events, so that the device may avoid writing multiple data points it recognizes to have occurred close together in time and may record whatever reference information might be utilized to extract a time base in the future. In the case of RF sensing, since a GSM cell phone (or a WIFI/WIMAX/BT device) is known to beacon at regular intervals, the beacons of one of these nearby stationary devices may be used to establish a time base for other sensed events.

In one embodiment, the tag might be considered a “snoop” tag which records a list of wirelessly beaconed IDs or medium access control (MAC) addresses over time. Such “snoop” tags may be placed at entry and exit points of public spaces (and transportation systems such as aircraft) to monitor for suspected criminals or unauthorized persons. A security person may scan the tags with a mobile device comprising an integrated RFID reader that connects to a network to flag potential suspects.

In some embodiments, the component 34 can be operated with power derived from both the reader 24 and mobile communication device 40 simultaneously or at different times depending on which of the reader 24 or mobile communication device 40 is within range of the tag 30.

FIG. 2 shows an illustrative implementation of at least part of the system of FIG. 1. In particular, FIG. 2 shows a human body 200 having one or more biological parameters that are monitored using the system described herein. The human body 200 may be that of a hospital patient or outpatient, for example. In at least some embodiments, an animal may be substituted for the human body 200 (e.g., in a veterinarian's medical facility). As described below, the system may be used to monitor and/or collect biological parameters that include temperature, cardiovascular (e.g., electrical signals), pulmonary signals and respiration rate, neurological signals, blood pressure, blood gas levels, blood chemistry, as well as heart, lung and gastrointestinal sounds, etc.

One or more sensors 202 may couple to the body 200. For example, as shown, sensor 202a couples to the chest of the body 200; sensors 202b and 202c couple to the body's abdomen; and sensor 202d couples to the body's upper arm. Fewer sensors or additional sensors may be used. The sensors may be of any suitable type(s) and/or size(s) and may be used for various functions. For example, the sensor 202a may be used to monitor the body's pulse. Alternatively, or in addition, sensors 202a-202c may be used in concert to perform an electrocardiogram test on the body 200. Similarly, the sensor 202d may determine the body's blood pressure. Such sensors may be used to monitor any, or virtually any, biological parameter. Besides being implanted on skin, the sensors also may be coupled to clothes, to skin using adhesive bandages, to various body parts (e.g., eyes, nose, ears, fingertips, wrist, etc.). The sensors also may be implanted subcutaneously. Any and all such variations are included within the scope of this disclosure.

Each sensor 202 has embedded therein a tag 30 or a tag similar to the tag 30. The tag 30 embedded in each sensor 202 comprises a transmitter (e.g., transceiver) that is capable of receiving a signal from a base device 204 and responding to the base device 204 via transmission of a reply signal. As explained in detail above, the reply signal contains various information, including information identifying the sensor 202 as well as any additional data collected by the sensor 202. The component 34 in each tag comprises circuit logic that is capable of detecting various biological parameters and providing them to the transceiver 32 for transmission or to storage (not specifically shown). The biological parameters may also be or alternatively be transmitted to the mobile communication device 40 (e.g., in the form of a text message or voice message).

The base device 204 is a generic device that may comprise the reader 24, the mobile communication device 40, or some other suitable device. Each sensor 202 is powered by electrical current induced in the sensor 202 by wireless transmissions from the base device 204, as described in detail above. FIG. 3 shows an illustrative block diagram of the base device 204. The base device 204 comprises processing logic 302 (e.g., a processor, preferably a digital signal processor (DSP)), a transceiver 304 (comprising a transmitter and receiver), an antenna 306 and storage 308 comprising software code 310. The software code 310, when executed by the processing logic 302, causes the processing logic 302 to implement the techniques disclosed herein. As previously explained, sensors 202 derive power from wireless transmissions emitted by the base device 204. The sensors 202 use that power to sense and collect data, to transform the data from analog to digital form, and to transmit the data wirelessly to the base device 204 or to some suitable device. The transmissions from which the sensors 202 derive their power may be emitted by the base device 204 in different ways. Any suitable technique may be used, including backscattering, load-modulation and active transmission.

The base device 204 may take any suitable form. For example, the base device 204 may couple to a bed, to clothes, to skin, to a wall unit in the room, to a stand, or to other key areas in a house or building. The base device 204 also may be worn, for example, around the neck, around the wrist, in a pocket or fanny pack, etc. In some embodiments, the base device 204 receives power from an electrical wall outlet (e.g., an alternating current (AC) outlet). In other embodiments, the base device 204 is battery-powered, enabling the base device 204 to be portable, or at least easier to move than a base device that is coupled to an electrical outlet in a wall. Power hardware is not specifically shown in FIG. 3.

The base device 204, the sensors 202 and communications therebetween may be customized as desired. For example, in some embodiments, communications between the base device 204 and the sensors 202 may be encrypted using key exchange mechanisms. In this way, sensed data (e.g., sensitive medical information) remains private. In some embodiments, the software code 310 may be programmed so that the processing logic 302, upon receiving sensed data from a sensor 202, performs post-processing on the data to manage the sensed data. For example, data received by the base device 204 may be analyzed to diagnose medical conditions (e.g., if the sensed blood pressure exceeds a predetermined threshold, hypertension may be diagnosed). The software code 310 may be programmed in this way to diagnose any medical condition using sensed data. In some embodiments, if a sensed parameter is out of a predetermined range, the base device 204 may emit an alert signal. For example, if no pulse is detected on a patient, an alert signal may be transmitted to a nearby nurse station. Sensed data also may be used to titrate medication or to adjust automated treatments being provided to a patient. For instance, if the base device 204 determines (using sensed data) that a patient's blood chemistry is abnormal, the base device 204 may transmit a wireless (or wired) signal to a separate device (e.g., a computerized intravenous (IV) drip) that adjusts the medication provided to the patient. Sensed data, along with results of analyses performed on the sensed data, may be transmitted by the base device 204 to any other device using any suitable protocol (e.g., cellular protocols, Ethernet and Wi-Fi Internet, central monitoring stations in hospitals, etc.). Any collected information also may be automatically posted on a Website or other network location accessible by a computing device. The various actions described above may be performed by the base device 204, a tag 202, multiple tags 202, a mobile communication device 40, or other suitable device. Any and all such variations and permutations are encompassed within the scope of this disclosure.

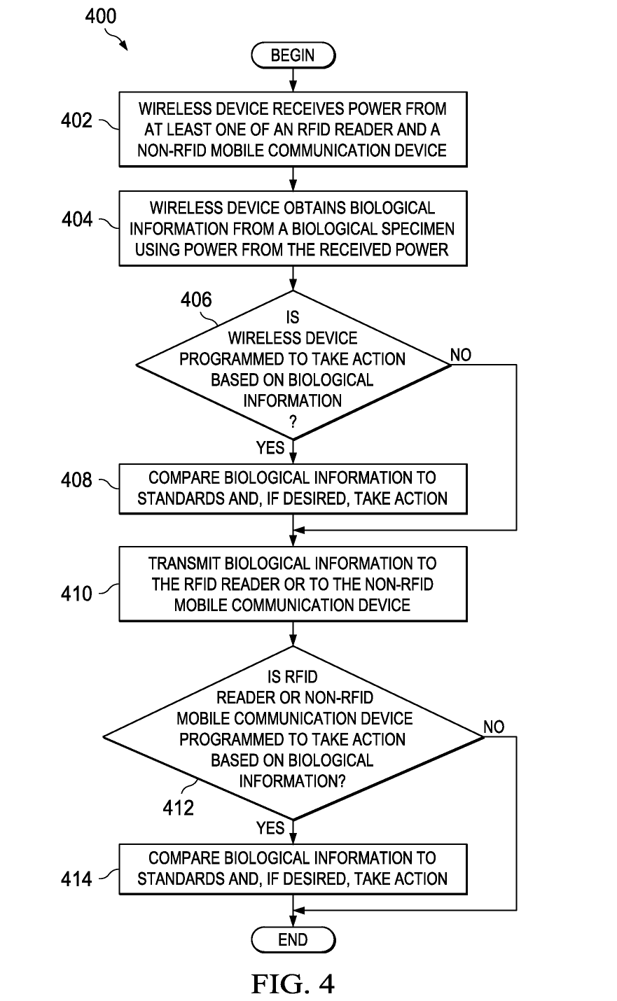

FIG. 4 shows a flow diagram of an illustrative method 400 in accordance with embodiments. The method 400 begins with a wireless device receiving power from at least one of an RFID reader and a non-RFID mobile communication device (or, optionally, a stationary device) (block 402). The method 400 continues with the wireless device obtaining biological information from a biological specimen using power from the received power (block 404). The method 400 further continues by determining whether the wireless device is programmed to take action based on biological information (block 406). If so, the method 400 comprises comparing biological information to standard(s) (e.g., threshold(s)) and, if the comparison warrants it, taking action (e.g., diagnosing a medical condition, generating an alert signal, providing an alert signal to a nurse station, automatically titrating medication, adjusting automated treatments, transmitting biological information to another device, and posting the biological information to a Website (private or public) or other network location accessible by a computing device) (block 408).

The method 400 still further comprises transmitting the biological information to the RFID reader or to the non-RFID mobile communication device (or stationary device) (block 410). The method 400 then comprises determining whether the RFID reader or non-RFID mobile communication device (or stationary device) is programmed to take action based on biological information (block 412). If so, the method 400 comprises comparing the biological information to standard(s) (e.g., threshold(s)) and, if the comparison warrants it, taking one or more actions such as those described above (block 414). The steps described above may be adjusted as desired (i.e., steps may be added, deleted or modified).

While the preferred embodiments of the present invention have been shown and described, modifications thereof can be made by one skilled in the art without departing from the spirit and teachings of the invention. For example, the communication between the communication device and tag/reader in FIG. 1 can be infra-red (IR)-based instead of radio frequency (RF)-based as in the case of RFID. Further, in some embodiments, the tag wirelessly receives power from an external radio frequency (RF) source other than an RFID reader or mobile communication device. The scope of protection is not limited by the description set out above. Each and every claim is incorporated into the specification as an embodiment of the present invention.

What is claimed is:

1. A radio frequency identification (RFID) tag, comprising:
a transceiver; and
a component coupled to said transceiver, the component adapted to collect at least one biological parameter;
wherein the transceiver is adapted to wirelessly receive power from a base device, said power received from the base device used to power said component.

2. The RFID tag of claim 1, wherein the component is powered only using said power received wirelessly from the base device.

3. The RFID tag of claim 1, wherein the component is powered using at least one of said power received wirelessly from the base device and a mobile communication device in wireless communication with the RFID tag.

4. The RFID tag of claim 1, wherein the component comprises a sensor selected from the group consisting of a cardiovascular sensor and a pulmonary sensor.

5. The RFID tag of claim 1, wherein said biological parameter comprises a parameter selected from the group consisting of temperature, cardiovascular electrical signals, neurological signals, blood pressure, blood gas levels, blood chemistry and respiration rate.

6. The RFID tag of claim 1, wherein the tag is able to collect said at least one biological parameter from at least one of a human and an animal.

7. The RFID tag of claim 1, wherein the tag couples to skin, clothes or body parts when collecting said biological parameter.

8. The RFID tag of claim 1, wherein the tag, as a result of a comparison of said biological parameter and a threshold, directly or indirectly causes an action to automatically be performed, said action selected from the group consisting of:
diagnosing a medical condition;
generating an alert signal;
providing an alert signal to a nurse station;
titrating medication;
adjusting automated treatments;
transmitting said biological parameter to another device; and
posting said biological parameter to a Website or other network location accessible by a computing device.

9. A method, comprising:
a wireless device receiving power from at least one of an RFID reader and a non-RFID mobile communication device;
the wireless device obtaining biological information from a biological specimen, the obtainment of said biological information powered by said received power; and
transmitting said biological information to said RFID reader or to said non-RFID mobile communication device.

10. The method of claim 9, wherein transmitting said biological information to said non-RFID mobile communication device comprises generating and transmitting a text message.

11. The method of claim 9, wherein said biological information comprises data selected from the group consisting of temperature, cardiovascular electrical signals, neurological signals, blood pressure, blood gas levels, blood chemistry and respiration rate.

12. The method of claim 9 further comprising said wireless device being powered only using said received power.

13. The method of claim 9 further comprising comparing said biological information to a threshold, and if said biological information meets or exceeds said threshold, then, as a result, automatically performing an action selected from the group consisting of:
diagnosing a medical condition;
generating an alert signal;
titrating medication;
adjusting automated treatments;
transmitting said biological information to another device; and
posting said biological information to a Website or other network location accessible by a computing device.

14. A system, comprising:
means for receiving power from at least one of an RFID reader and a non-RFID means for communication;
the means for receiving also for obtaining biological information from a biological specimen, the obtainment of said biological information powered by said received power; and
the means for receiving also for transmitting said biological information to said RFID reader or to said non-RFID means for communication.

15. The system of claim 14, wherein the means for receiving couples to the biological specimen subcutaneously or via an organ.

16. The system of claim 14, wherein the means for obtaining comprises a cardiovascular sensor and a pulmonary sensor.

17. The system of claim 14, wherein the means for obtaining is capable of analyzing the biological specimen's blood chemistry, temperature, neurological signals, cardiovascular signals, pulmonary signals and blood pressure.

18. The system of claim 14, wherein the means for receiving, as a result of a comparison of said biological information and a threshold, directly or indirectly causes an action to automatically be performed, said action selected from the group consisting of:
diagnosing a medical condition;
generating an alert signal;
providing an alert signal to a nurse station;
titrating medication;
adjusting automated treatments;
transmitting said biological information to another device; and
posting said biological information to a Website or other network location accessible by a computing device.
